(19) United States
(12) Patent Application Publication
(10) Pub. No.: US 2005/0270783 A1
(43) Pub. Date: Dec. 8, 2005

(54) Device for reducing dark lines on light scattering guide plate

(75) Inventors: Ming Dah Liu, Miao-Li County (TW); Shi Chi Hou, Miao-Li County (TW); Hao Jan Kuo, Miao-Li County (TW); Jui Nien Jao, Miao-Li County (TW)

Correspondence Address: BIRCH STEWART KOLASCH & BIRCH, PO BOX 747, FALLS CHURCH, VA, 22040-0747, US

(73) Assignee: Coretronic Corporation

(21) Appl. No.: 10/983,730

(22) Filed: Nov. 9, 2004

(30) Foreign Application Priority Data
Jun. 8, 2004 (TW) 093116479

(51) Int. Cl. G02B 5/02; F21V 5/00

(52) U.S. Cl. 362/376; 362/558

(57) ABSTRACT

A device for reducing the dark lines on a light scattering guide plate according to the present invention comprises a light scattering guide plate and at least one vein is disposed on a part of the surface of the light incident side thereof. At least one light tube is installed at the outer end of light incident side of the guide plate and a reflecting cover used to cover the light tubes is installed at the light incident side of the guide plate. Therefore, a beam can be scattered or converged to cause the dark lines around the light incident side to be shrunk or weakened effectively to enhance the light uniformity of the entire guide plate.

### BACKGROUND OF THE INVENTION

1. Field of the Invention

The present invention relates to a device for reducing the dark lines on a light scattering guide plate, and more particularly to a device used for reducing the dark lines on a light scattering guide plate.

2. Description of Related Art

Please refer to FIG. 1. A back light module of a conventional liquid crystal display comprises a transparent light scattering guide plate 1 of which light tubes 2 are installed at one or two flank side(s); beams are projected into the light scattering guide plate 1 through the light tubes and finally projected out from a upper surface 3 of the light scattering guide plate 1 so as to provide a face light origin for a liquid crystal element to allow the light crystal element to display images. However, because fewer beams are provided by the light tubes at an area between the light tubes 2 or far away from the light tube, a light energy vacancy zone 4 is formed after the light beams are projected into the area at the light scattering guide plate 1. The vacancy area 4 is transmitted to another side of the light scattering guide plate 1 complying with the total reflection effect of the light scattering guide plate to cause many dark lines 5 formed on the surface of the light scattering guide plate 1 so that the uniformity of luminance is not good to influence the picture quality. But, accompanying the requirement of high brightness, the number of light tubes is increased or the distance between two adjacent tubes is increased so that the light energy vacancy zones become more or wider, the dark lines showed on the surface of the light scattering guide plate 1 also relatively become more or wider so that the image quality are seriously influenced.

Therefore, how to weaken and reduce the dark lines of a picture on a light scattering guide plate so as to allow the luminance of the guide plate to be more uniform is the subject of the present invention.

### SUMMARY OF THE INVENTION

One object of the present invention is to provide a device for reducing the dark lines on a light scattering guide plate, used for changing the angle of a beam incident in the guide plate by disposing veins on the surface of the light incident side of the guide plate so as to reduce and weaken the dark lines on the surface of the guide plate to enhance the luminance uniformity of the entire guide plate.

Another object of the present invention is to provide a device for reducing the dark lines on a light scattering guide plate, causing the beam incident in the guide plate to be scattered or converged by means of a lenticular lenses structure disposed on the surface of the light incident side of the guide plate so as to solve the dark lines problem caused from the surface of a conventional light scattering guide plate effectively.

Still another object of the present invention is to provide a device for reducing the dark lines on a light scattering guide plate, capable of diffracting the beam incident in linear veins up and down and guiding it out from the upper surface of the guide plate by disposing the linear veins in the longitudinal direction of parallel light tubes.

Still, still another object of the present invention is to provide a device for reducing the dark lines on a light scattering guide plate, allowing the manufacturing of the guide plate to be simpler and the guide plate to have a mass production capability by fabricating linear veins with a simple structure on a sliding piece of an injection mold.

For attaining to the objects mentioned above, a device for reducing the dark lines on a light scattering guide plate according to the present invention comprises a light scattering guide plate and at least one vein is disposed on a part of the surface of the light incident side thereof. At least one light tube is installed at the outer end of light incident side of the guide plate and a reflecting cover used to cover the light tubes is installed at the light incident side of the guide plate. An angle, of an incident light projected on the guide plate is caused to change by disposing the veins on the surface of the light incident side so that a beam can be scattered or converged to cause the dark lines around the light incident side to be shrunk of weakened effectively to enhance the luminance uniformity of the entire guide plate.

### BRIEF DESCRIPTION OF THE DRAWINGS

The present invention can be more fully understood by reference to the following description and accompanying drawings, in which:

FIG. 1 is a schematic view, showing a back light module structure of the prior art;

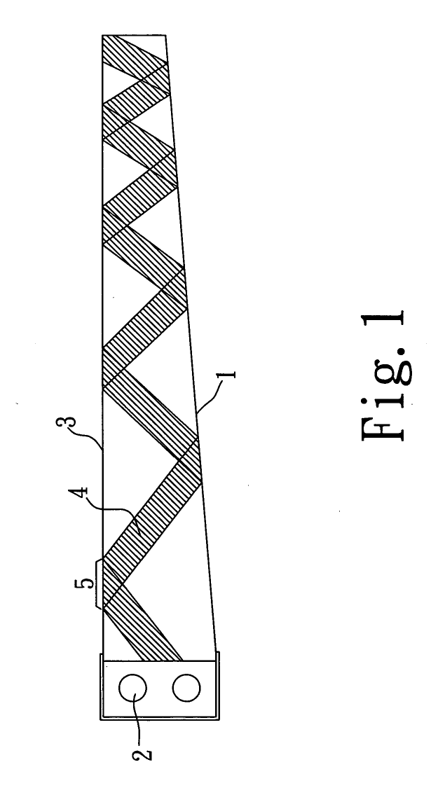

FIG. 2 is an explosive view, showing a device for reducing the dark lines on a light scattering guide plate according to the present invention;

FIG. 3 is a schematic view, showing a device for reducing the dark lines on a light scattering guide plate of a first preferred embodiment according to the present invention;

FIG. 4 is a schematic view, showing a device for reducing the dark lines on a light scattering guide plate of a second preferred embodiment according to the present invention;

FIG. 5 is a schematic view, showing a device for reducing the dark lines on a light scattering guide plate of a third preferred embodiment according to the present invention;

FIG. 6 is a flow chart, showing processes of a manufacturing method for a light scattering guide plate of a device for reducing the dark lines on a light scattering guide plate according to the present invention; and

FIG. 7 is a prospective view, showing a structure of a mold set of a device for reducing the dark lines on a light scattering guide plate according to the present invention.

### DETAILED DESCRIPTION OF THE PREFERRED EMBODIMENTS

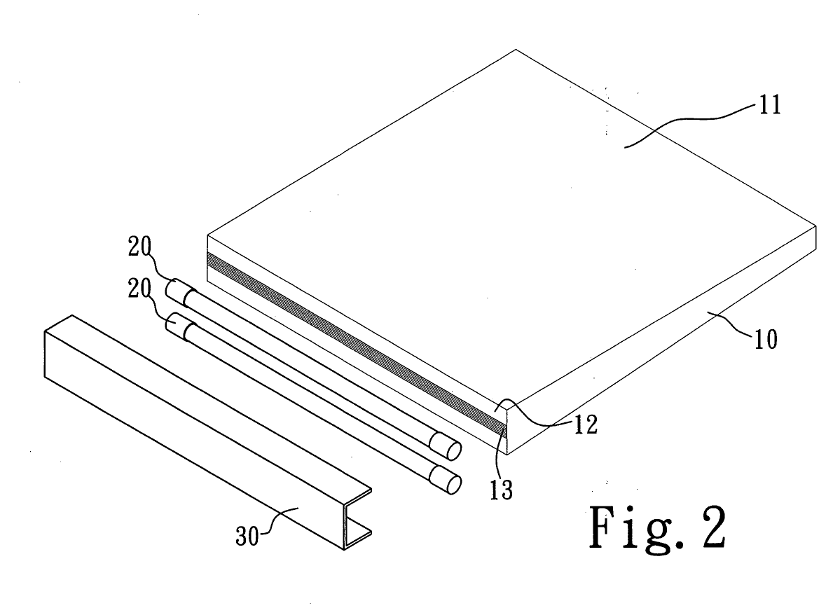

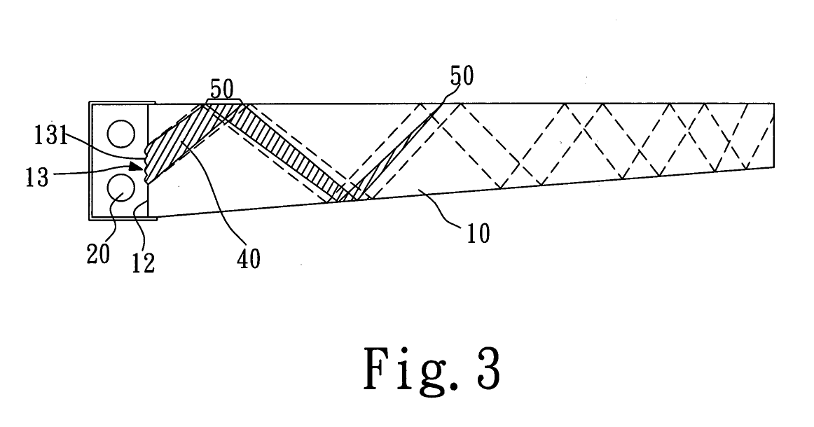

Please refer to FIGS. 2 and 3. a device for reducing the dark lines of a light scattering guide plate comprises a light scattering guide plate 10, at least one light tube installed at the outer end of a light incident side 12 of the light scattering guide plate 10 and a reflecting cover 30 covered outside of the light tubes 20 and disposed at the outer end of the light incident side 12, in which at least one linear vein 13 is disposed on the entire or a part of surface of the light incident side 12 of the guide plate 10. The shape of each linear vein 3 and the distance between each two adjacent veins is decided depending on the brightness of the beam incident at the light incident side. The longitudinal direction of the linear vein 13 is parallel to the longitudinal direction of the light tube 20 and the length of the linear vein 13 is approximately equal to the width of light incident side 12. Furthermore, the cross sectional shape of the linear vein 13 can be a geometrical shape such as a triangle or half circle, or a lenticular convex or concave lens, and can be disposed at a light energy vacancy zone 40 between the two adjacent light tubes or far away from the light tubes 20, or a position corresponding to the light tube 20. And, the reflecting cover 30 is used for allowing the beam emitted from the tube 20 to be projected into the guide plate 10 after being reflected. The incident angle of the beam projected into the guide plate 10 is objected to change by means of the disposition of the linear veins 13 so as to weaken of shrunk the dark lines on a upper surface 11 of the guide plate 10. The linear veins 13 on the light incident side 12 of the guide plate 10 are disposed as being parallel to the longitudinal direction of the light tube 20. A beam can be diffracted up and down when it is projected into the linear veins 13 and is guided out from the upper surface (i.e. the direction of a line of vision) of the guide plate 10.

Please refer to FIG. 3. When the veins 13 of the light incident side are disposed between the two adjacent light tubes 20 and lenticular convex lenses 131 are adopted, the beam in the vacancy zone 40 is converged to shrink (the portion surrounded by dotted lines is the vacancy zone of a conventional structure) when a beam projected into the veins 13 of the light incident side 12 is objected to the curvature effect of the surface of the convex lens 131. Whereby, the dark lines 50 formed on the surface of the guide plate 10 can be allowed to shrink gradually.

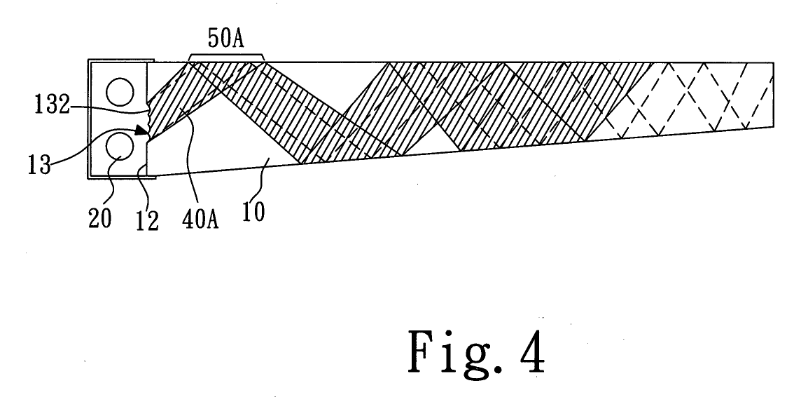

Please refer to FIG. 4. When the veins 13 of the light incident side are disposed between the two adjacent light tubes 20 and lenticular concave lenses 132 are adopted, the beam in the vacancy zone 40A is scattered to enlarge (the portion surrounded by dotted lines is the vacancy zone of a conventional structure) when a beam projected into the veins 13 of the light incident side 12 is objected to curvature effect of the surface of the concave lens 132. Whereby, the dark lines 50A formed on the surface of the guide plate 10 are allowed to weaken and the uniformity of luminance can be enhanced.

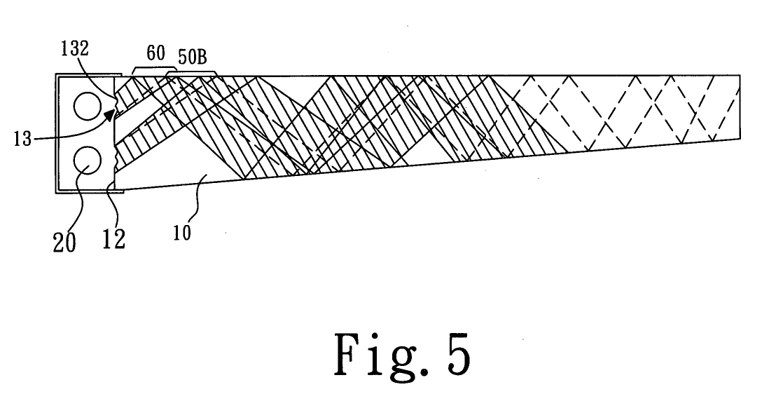

Please refer to FIG. 5. When the veins 13 of the light incident side 12 are disposed corresponding to the positions of the light tubes and the lenticular concave lenses 132 are adopted, high energy beams corresponding to the position of the light tubes 20 are caused to project into the veins on the guide plate 10, the high energy beams are caused to scatter through the veins 13 to enlarge the zone of bright lines 60 (the portion surrounded by dotted lines is the vacancy zone of a conventional structure). Whereby, the zone of dark lines 50B can be covered by the zone of the bright lines so as to enhance the brightness of the zone of the dark lines 50B to enhance the uniformity of luminance of the entire guide plate.

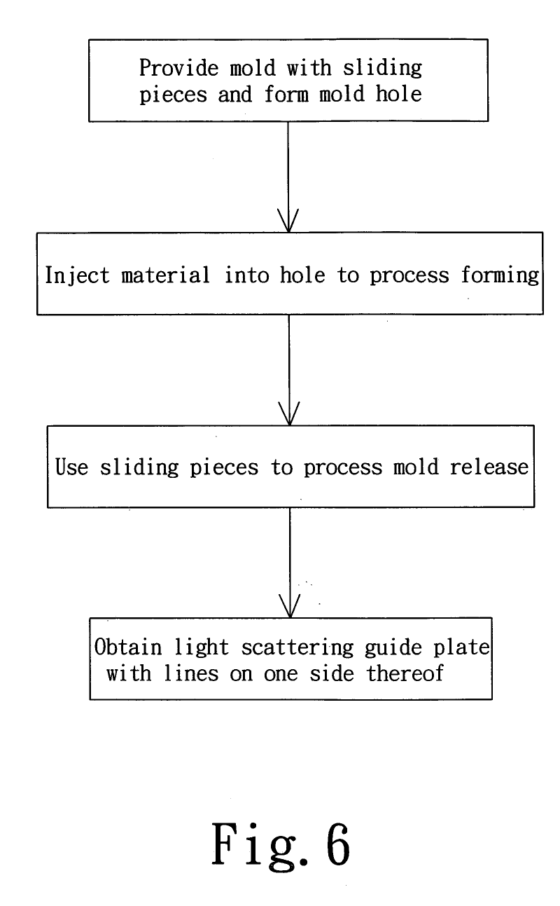

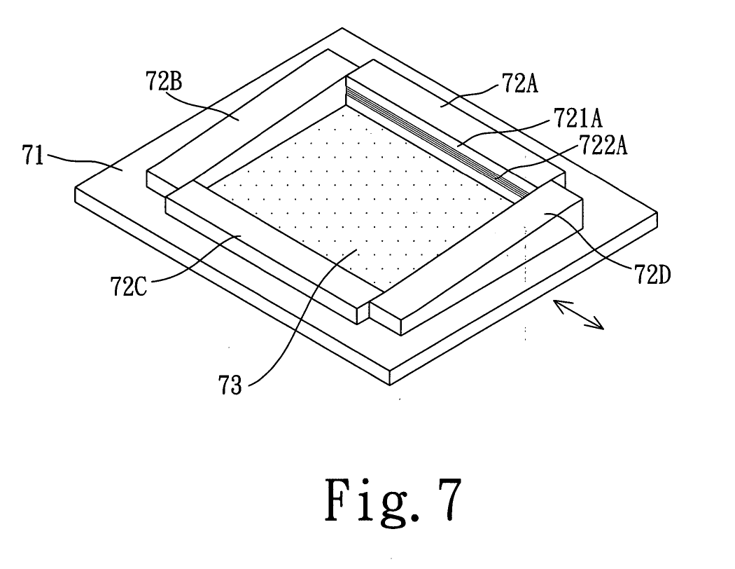

Furthermore, please refer to FIGS. 6 and 7. The figures respectively show a manufacturing method for the guide plate 10 and molds used in this method according to the present invention. First, a set of molds are provided. The mold set comprises a upper mold, lower mold, thin sheet 71 installed between the upper and the lower molds and four sliding pieces 72A, 72B, 72C and 72D in which the sliding pieces 72A, 72B, 72C and 72D are installed around the thin sheet 71 (shown in FIG. 7). Veins 722A whose shape is opposite to the shape of the already decided shape of the veins is disposed on the inner side face 721A of the sliding piece 72A so as form a mold holes 73 with the veins formed on the side face 721A. And, a material is then injected into the mold hole to process forming. Finally, the upper and the lower molds are opened and the sliding pieces 72A, 72B, 72C and 72D are moved to form a light scattering guide plate with the veins on the side face thereof by means of mold release (as FIG. 3 shows). Therefore, the light scattering guide plate 10 can be fabricated by injection molding operated in coordination with the mold set with the sliding pieces 72A, 72B, 72C and 72D so that the mass productivity and quality stability are good.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A device for reducing dark lines on a light scattering guide plate, comprising:
a light scattering guide plate, having at least one light incident side and at least one linear vein disposed on a part surface of said light incident side;
at least one light tube, installed outside of said light incident side of said light scattering guide plate;
a reflecting cover, covering said light tube(s) at said light incident side of said guide plate, whereby, a beam or beams from said light tube(s)is projected into said guide plate by means of the reflection of said reflecting cover.

2. The device according to claim 1, wherein a longitudinal direction of said linear vein is parallel to a longitudinal direction of said light tube.

3. The device according to claim 1, where said part surface is corresponding to the location of said tube.

4. The device according to claim 1, wherein said part surface is disposed a light energy vacancy zone between said two adjacent light tubes.

5. The device according to claim 1, wherein said part surface is disposed at a location far away from a light energy vacancy zone of said lamp.

6. The device according to claim 1, wherein said linear vein is made by a lenticular lens.

7. The device according to claim 6, wherein said lens is a concave lens for scattering a beam from said light tube projected into said part surface of said light incident side.

8. The device according to claim 6, wherein said lens is a convex lens for converging a beam from said light tube projected into said part surface of said light incident side.

9. The device according to claim 1, wherein a cross sectional shape of each said linear vein is any geometric shape.

10. The device according to claim 1, wherein the length of said linear vein is approximately to the width of said light incident side.

11. The device according to claim 1, wherein a longitudinal direction of said lighting tube is parallel to the width direction of said light incident side of said guiding plate.

12. The device according to claim 1, wherein the shape of each linear vein is made by utilizing a mold set with sliding pieces and by means of injection molding.

13. The device according to claim 1, wherein the shape of each said vein and a distance between said two adjacent veins is set by the brightness of a beam projected into said light incident side.

14. A device for reducing dark lines on a light scattering guide plate, comprising:
a light scattering guide plate, having at least one light incident side and at least one linear vein disposed on a surface of said light incident side;
at least one light tube, installed outside of said light incident side of said light scattering guide plate, the longitudinal direction of said light tube is parallel to the longitudinal of said linear vein;
a reflecting cover, covering said light tube(s) at the light incident side of said guide plate, whereby, a beam or beams from said light tube(s) is projected into said guide plate by means of the reflection of said reflecting cover.

15. A manufacturing method for a light scattering guide plate, comprising the following steps:
(A) providing a mold set, said mold set comprising a thin sheet and at least one sliding piece so as to form a mold hole with veins at one side thereof;
(B) injecting a material into said mold hole to process forming; and
(C) using said sliding pieces to process mold release so as to fabricate a light scattering guide plate with veins on a side face thereof.

16. The method according to claim 15, wherein said sliding pieces are installed around said thin sheet, and veins have an opposite shape to the shape of a predetermined structure disposed at the inner side face of at least one of said sliding pieces.
